(19) United States
(12) Patent Application Publication
(10) Pub. No.: US 2013/0046503 A1
(43) Pub. Date: Feb. 21, 2013

(54) TESTING SYSTEM AND METHOD HAVING WIRELESS DATA TRANSMISSION CAPABILITY

(71) Applicants: Chun-Lin Huang, Taipei (TW); Ching-Feng Hsieh, Taipei (TW)

(72) Inventors: Chun-Lin Huang, Taipei (TW); Ching-Feng Hsieh, Taipei (TW)

(73) Assignees: ASKEY COMPUTER CORPORATION, Taipei (TW); ASKEY TECHNOLOGY (JIANGSU) LTD., Jiangsu Province (CN)

(21) Appl. No.: 13/308,508

(22) Filed: Nov. 30, 2011

(30) Foreign Application Priority Data
Aug. 18, 2011 (TW) 100129506

(51) Int. Cl. G06F 19/00

(52) U.S. Cl. 702/117

(57) ABSTRACT

Testing system and method with wireless transmission tested data function are provided. An electronic device performs self-testing by a testing program or a testing instrument so as to generate tested data and transmits the tested data to a server via a wireless network. A processing device linked to the server via the wireless network obtains and processes the tested data so as to generate processed data. The processing device further transmits the processed data to the server via the wireless network. Accordingly, the processing device immediately and remotely monitors the electronic device, which is located on a production line, thereby effectively reducing manpower and costs.

### BACKGROUND OF THE INVENTION

1. Field of the Invention

The present invention relates to testing systems and methods, and, more particularly, to a testing system and a method with wireless transmission tested data function.

2. Description of Related Art

Followed by the development of technology, portable electronic devices, such as intelligent mobile phones, tablet computers, E-book readers, digital cameras, micro notebook computers and the like have a variety of functions that are greatly improved. Nowadays, in addition to an original talking function, an electronic device usually combines functions of photographing, surfing, playing, reading and document processing, and thus undoubtedly becomes a multifunctional electronic device while each function has to be tested many times before going out of a factory.

With respect to the present production line, a production line of electronic devices is primarily tested by people. Please referring to FIG. 1, an operator 10 tests an electronic device 11 with hands and transmits a log generated by testing the electronic device 11 to a terminal device 12 such as a computer via a bus such as a Universal Serial Bus (USB). The operator 10 can roughly determine whether errors are generated or not during testing procedure via the terminal device 12 and then transmits the log to a server 13 via a cable 15 by using the terminal device 12. After that, an engineer download the log by using a processing device 14 to link the server 13 via the cable 15. The engineer checks the log of test of the electronic device 11 on the processing device 14 so as to determine whether unanticipated problems are generated or not during testing procedure and provides solutions suitable for the problems after analyzing and comparing the log.

However, for example, usual problems on manual control test and transmission are that uncompleted scan by a scanner or uncompleted file transmission result in not capable of clearly transmitting the testing procedure of the electronic device and even in affecting testing and transmission efficiency. In addition, the efficiency of the testing production line of a traditional electronic device is poor. As illustrated in FIG. 1, the server 13 is connected to a processing device 14 and a terminal device 12 via the cable 15, and the terminal device 12 is connected to an electronic device 11 via a bus. In other words, the aforementioned instruments or devices are connected to one another via solid lines. Thus, the server 13 merely can receive a testing log of one electronic device 11 each time and can transmit it to one processing device 14 for engineers to check. If engineers would like to check the testing condition of another electronic device 11, they have to go to another processing device connected to another server to check it.

Therefore, since efficiency of manual control is limited and transmission range of solid lines are also limited, a traditional testing method needs a great deal of manpower, lines and many kinds of devices such that errors are hard to be immediately solved once being generated during a great deal of testing procedures.

### SUMMARY OF THE INVENTION

In light of the various problems of the prior art, the present invention provides a testing system and method with wireless transmission tested data function which can reduce manpower and costs while improving the testing efficiency so as to achieve the multiplex effect.

The testing system with wireless transmission tested data function provided by the present invention is suitable for a wireless network, comprising: an electronic device for performing self-testing and generating tested data; a server that receives the tested data via the wireless network and stores the tested data; and a processing device that is linked to the server via the wireless network so as to obtain and process the tested data so as to generate processed data.

Since the test of the electronic device is designed to an automatic test and the tested data of electronic device is automatically transmitted by using the wireless network, problems of poor testing efficiency and limited transmission range resulted from human control and solid line transmission can be avoided. In addition, the server can be linked to more than one electronic device and processing device via the wireless network. Therefore, an engineer can obtain tested data of a plurality of electronic devices on one processing device without rushing to a processing device located at each of a plurality of production lines. Hence, it can greatly transmit data via the wireless network so as to achieve multiplex performance and render the engineer to immediately do a reaction and perform improvement and process.

In addition, the testing system with wireless transmission tested data function of the present invention further comprises a testing module that is a testing program loaded in the electronic device or a testing instrument connected to the electronic device.

Further, the testing system with wireless transmission tested data function of the present invention further comprises an automatic transmission module, and the electronic device transmits the tested data to the server via the wireless network by using the automatic transmission module, wherein the automatic transmission module is disposed in the electronic device or an automatic transmission apparatus connected to the electronic device.

The testing method with wireless transmission tested data function provided by the present invention stores tested data of an electronic device in a server via a wireless network and processes the tested data by a processing device, the testing method comprising the steps of: (1) enabling the electronic device to perform self-testing so as to generate tested data; (2) transmitting the tested data to a server via a wireless network; (3) linking a processing device to the server via the wireless network so as to obtain the tested data; and (4) rendering the processing device to process the tested data so as to generate processed data. The testing method can further comprise: transmitting the processed data to the server via the wireless network.

Compared to the prior art, the testing system and method with wireless transmission tested data function of the present invention can avoid errors by people and effectively reduce manpower and costs during testing.

### BRIEF DESCRIPTION OF DRAWINGS

FIG. 1 is a schematic block diagram of testing a transmission system of an electronic device according to the prior art;

FIG. 2A is an architectural block diagram of a testing system with wireless transmission tested data function in accordance with the present invention;

FIG. 2B is an architectural block diagram of an embodiment of the testing system with wireless transmission tested data function in accordance with the present invention; and

FIG. 3 is a flow chart of a testing method with wireless transmission tested data function in accordance with the present invention.

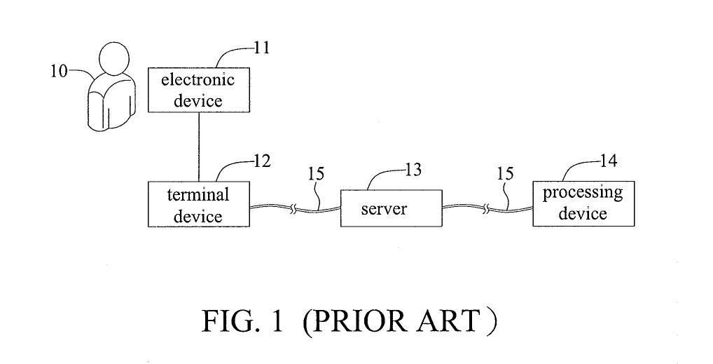

### DETAILED DESCRIPTION OF PREFERRED EMBODIMENTS

The technical means and contents of the present invention will be illustrated by the following specific embodiments. One having common knowledge and ordinary skill in the art can readily understand other advantages and effects of the present invention from the disclosures of the specification.

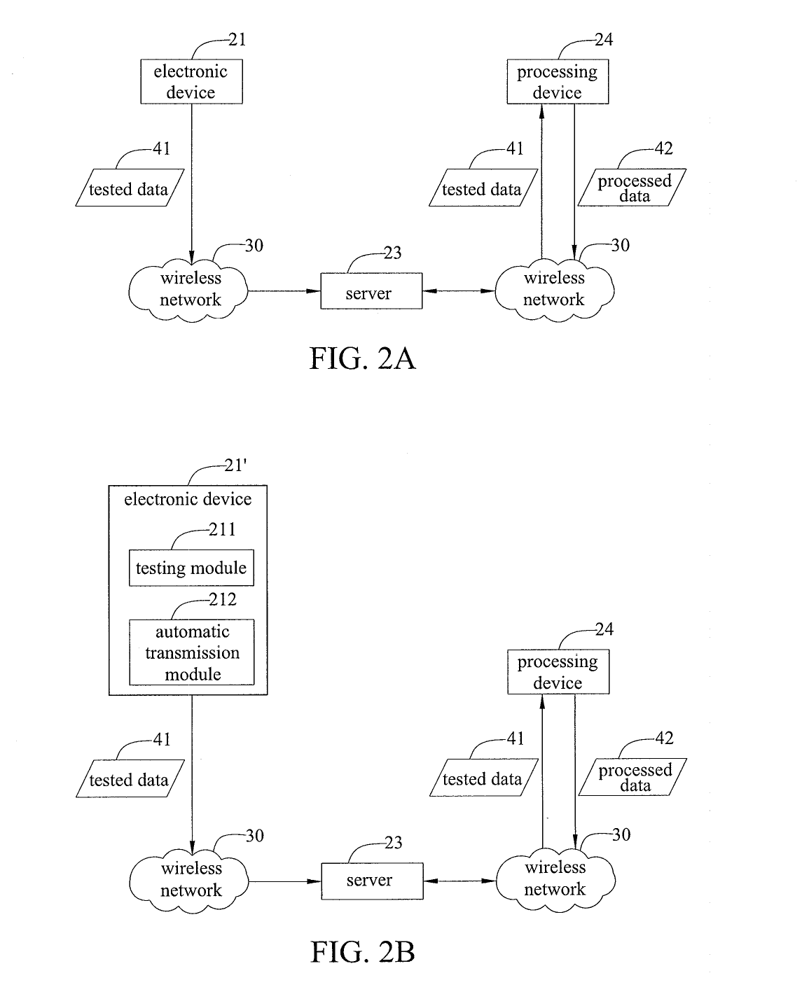

Please refer to FIG. 2A, which illustrates a testing system with wireless transmission tested data function in accordance with the present invention which is suitable for, but not limited to, a wireless network 30, for instance, Wi-Fi. The testing system with wireless transmission tested data function primarily comprises an electronic device 21, a server 23 and a processing device 24.

The electronic device 21 performs self-testing to generate tested data 41. The electronic device 21 can be a tablet computer, a notebook computer or a mobile phone and the like. For example, the performed self-test can test the operation condition of, the resolution of an image captured by, or the accuracy of a barcode scanned by a camera, a scanner and the like on the electronic device 21. The tested data 41 is a log generated when the electronic device 21 performs the self-test. The electronic device 21 can automatically transmit the tested data 41 through the wireless network 30.

As illustrated in FIG. 2B, an electronic device 21′ can performs the self-test by using a testing module 211. The testing module 211 can be a testing program such as a computer program loaded in the electronic device 21′ or a testing instrument connected to the electronic device 21′. Furthermore, the electronic device 21′ can automatically transmit the tested data 41 to the server 23 by using an automatic transmission module 212, wherein the automatic transmission module 212 can be disposed in the electronic device 21′ or be an automatic transmission apparatus connected to the electronic device 21′.

Please simultaneously referring to FIGS. 2A and 2B, the server 23 is linked to the wireless network 30 provided for the electronic device 21 to upload the tested data 41 and for the processing device 24 to download the tested data 41. Specifically, the server 23 can be a File transfer Protocol (FTP) server which can be provided for one or more electronic devices 21 or processing device 24 to connect by the wireless network 30.

The processing device 24 acquires the tested data 41 from the server 30 via the server 23 and processes the tested data 41 so as to generate processed data 42. The processing device 24 can further upload the processed data 42 to the server 30 via the wireless network 30. The processing device 24 is usually referred to as a device having a processor or with calculating function. In practice, an engineer can immediately monitor the testing procedure of the electronic device 21 by using the processing device 24. In other words, the engineer can check the tested data 41 and understand the testing result. If there are unanticipated problems, the processed data 42 is obtained after the engineer further processes the tested data 41 while a solution suitable for the problems is brought up.

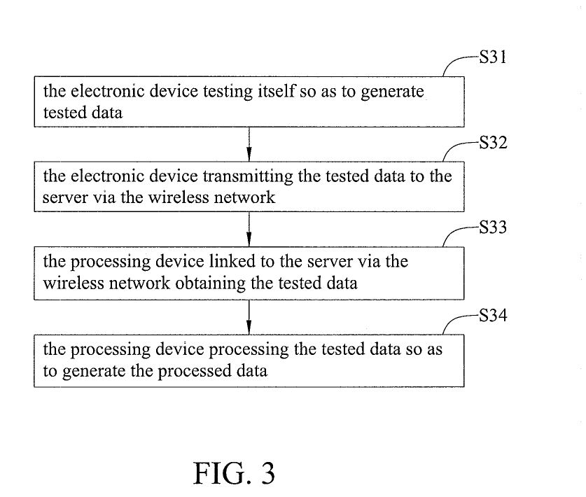

Please refer to FIG. 3, which illustrates a testing method with wireless transmission tested data function. In step S31, the electronic device performs the self-test so as to generate the tested data. In step S32, the electronic device transmits the tested data to the server via the wireless network. In step S33, the processing device is linked to the server via the wireless network so as to obtain the tested data. In step S34, the processing device processes the tested data so as to generate the processed data. In an embodiment, the testing method further comprises transmitting the processed data to the server via the wireless network.

For example, there is a barcode figure such as Barcode or QR code and the like at the bottom of many web pages introducing Android program, and an user can rapidly download a program to a mobile phone or a tablet computer by using a Barcode Scanner program in the mobile phone or the tablet computer to scan a barcode, thereby saving a lot of time for the user. Therefore, barcode scanning function of a camera has to be tested before a mobile phone or a tablet computer going out from a factory. By using the testing system and method with wireless transmission tested data function of the present invention, camera barcode scanning function of a mobile phone or a tablet computer can be automatically tested, and the tested data is automatically transmitted to a FTP server via the wireless network for an engineer to link the FTP server to obtain the tested data so as to realize the overall testing procedure.

It is known from the illustration of each figure, the present invention automatically tests the electronic device and transmits the tested result via the wireless network such that loss of customers and companies resulted from errors by people is avoided. Second, the characteristic of the wireless network not being limited to the transmission rage of a solid line can greatly increase the operation efficiency during researching and testing, that is, can perform a multiplex production test. Further, the real-time characteristic of the wireless network renders an engineer or a directing department to immediately obtain the tested result, thereby remotely monitoring, managing and modifying it.

In conclusion, the testing system and method with wireless transmission tested data function of the present invention have effects of being automatic, promoting the testing efficiency and immediately monitoring the testing procedure.

Each of the abovementioned embodiments is to exemplarily illustrate the principle, features and effects of the present invention, but not to limit the implement scope of the present invention. One having ordinary skill in the art can modify and change the abovementioned embodiments without departing from the spirit and scope of the present invention. Any equivalent change and modification completed by applying the disclosures of the present invention shall be covered by the appended claims. Hence, the scope of the present invention shall be recited in the appended claims.

What is claimed is:

1. A testing system having a wireless transmission tested data function, comprising:
an electronic device for performing self-testing and generating tested data;
a server for receiving the tested data via a wireless network and storing the tested data; and
a processing device linked to the server via the wireless network so as to obtain and process the tested data so as to generate processed data.

2. The testing system of claim 1, further comprising a testing module for the electronic device to perform self-testing via the testing module.

3. The testing system of claim 2, wherein the testing module is a testing program loaded in the electronic device.

4. The testing system of claim 2, wherein the testing module is a testing instrument connected to the electronic device.

5. The testing system of claim 1, further comprising an automatic transmission module for transmitting the tested data to the server via the wireless network.

6. The testing system of claim 5, wherein the automatic transmission module is disposed in the electronic device.

7. The testing system of claim 5, wherein the automatic transmission module is an automatic transmission apparatus connected to the electronic device.

8. The testing system of claim 1, wherein the processing device transmits the processed data to the server via the wireless network.

9. The testing system of claim 1, wherein the server is a File Transfer Protocol (FTP) server.

10. The testing system of claim 1, wherein the tested data is a log of a tested result of the electronic device.

11. A method having a wireless transmission tested data function, comprising the following steps of:
(1) enabling an electronic device to perform self-testing so as to generate tested data;
(2) transmitting the tested data to a server via a wireless network;
(3) linking a processing device to the server so as to obtain the tested data via the wireless network; and
(4) rendering the processing device to process the tested data so as to generate processed data.

12. The method of claim 11, further comprising the step of transmitting the processed data to the server via the wireless network.

13. The method of claim 1, wherein in step (1) the electronic device is tested by a testing instrument or a testing program.
